(19) United States
(12) Patent Application Publication
(10) Pub. No.: US 2011/0070408 A1
(43) Pub. Date: Mar. 24, 2011

(54) Material For Heat Transfer Decoration And Method For Manufacturing Same

(76) Inventors: Sylvain Antheme, Le Cheylard (FR); Dominique Devidal, Saint Agreve (FR)

(21) Appl. No.: 12/956,614

(22) Filed: Nov. 30, 2010

Related U.S. Application Data
(63) Continuation of application No. PCT/FR2009/050963, filed on May 25, 2009.

(30) Foreign Application Priority Data
May 30, 2008 (FR) 0853590

(51) Int. Cl. B32B 3/30; B29C 39/12; B32B 38/00

(52) U.S. Cl. 428/172; 264/299; 264/331.19; 264/255; 156/245

(57) ABSTRACT

Product for decorating a base material includes a sheet transferable by hot-pressing. A raised pattern is defined by the front surface of this transferable sheet whereof a shape-holding layer is obtained from a polyurethane-based solution having a high solids content having partial, prematurely blocked polymerisation. The invention is usable in the field of fabric decoration.

### CROSS-REFERENCE TO RELATED APPLICATIONS

The present application is a continuation of pending International patent application PCT/FR2009/050963 filed on May 25, 2009, which designates the United States and claims priority from French patent application 0853590 filed on May 30, 2008, the content of which is incorporated herein by reference.

### FIELD OF THE INVENTION

The present invention relates to the field of decoration using the hot-press transfer technique in which a sheet that carries or defines a decorative pattern is pressed by a heated element such as an iron onto a target base material. In particular, the invention has applications in the field of personalising garments and fabrics.

More precisely, the invention relates to a product for decorating a base material by using a hot-press transfer technique and a method for manufacturing such a product.

### BACKGROUND OF THE INVENTION

The hot-press transfer technique is implemented by using special products that are specially developed for this technique where a transferable sheet carries or defines the decorative pattern. This transferable sheet is generally combined with a backing sheet which is hot pressed and can be peeled off once transfer has been obtained.

The transferable sheet can be attached to the target base material by a thermofusible bonding layer that is heated during transfer so that it temporarily melts; this bonding layer is located on the opposite side to the peel-off sheet.

The decorative pattern can be produced by means of printing on the transferable sheet in which case the latter is, more precisely, a printable sheet.

The decorative pattern may also be cut out from the transferable sheet so that it is defined by the cut line once the off cuts have been removed.

Currently, the visual appearance of transferable sheets is the result of their colours and, if applicable, the texture of their constituent materials. As far as the Applicant is aware, no currently available transferable sheet is embossed or has any other raised pattern that can withstand hot-pressing at the time of transfer, i.e. is not degraded by being crushed at the time of hot-pressing.

### SUMMARY OF THE INVENTION

The present invention has at least the object of increasing the aesthetic possibilities of decorating base materials such as fabrics by using the hot-press transfer technique by allowing decoration attached using this technique to define a raised pattern such as embossing.

According to the invention, this object is achieved thanks to a product for decorating a base material by hot-press transfer comprising a sheet that can be transferred onto such a base material by hot pressing. A raised pattern is defined by the front surface of this transferable sheet which comprises at least one shape-holding layer which is obtained from a polyurethane-based solution having a high solids content having partial, prematurely blocked polymerisation.

It has been observed that, for reasons that have not yet been explained, the raised pattern of the sheet of such a product as defined above remains intact after such a sheet has been transferred by hot pressing. Such transfer can be performed onto a fabric, especially onto a garment or another base material such as a motor vehicle dashboard.

Advantageously, the sheet comprises a strengthening layer that covers said shape-holding layer and results from the drying of a polyurethane-based fully polymerised resin solution. Such a strengthening layer makes the sheet more resistant to mechanical stresses and, in particular, prevents premature crazing of this sheet.

Advantageously, said strengthening layer defines the front surface of the transferable sheet and comprises a superficial portion which is distinguished from an underlying portion of the strengthening layer by having a different colour and is located mainly in those areas that protrude from said front surface. When this is the case, a particular aesthetic effect resulting from a combination of two distinct localised colours having different depths can be obtained.

Advantageously, the transferable sheet comprises a bonding layer for attaching it to a target base material by hot-pressing.

Advantageously, on one side of the shape-holding layer, namely its side that is opposite the strengthening layer, the bonding layer covers one face of the shape-holding layer.

Advantageously, the product for hot-press transfer decoration comprises a backing sheet that carries the transferable sheet without covering the thermofusible bonding layer and can be peeled off in order to separate it from the transferable sheet once transfer has been accomplished. This backing sheet may be transparent in order to facilitate positioning the transferable sheet prior to fixing it by hot-pressing.

The object of the invention is also a method for manufacturing a product that is designed to decorate a base material and which comprises a sheet that can be transferred by hot-pressing. The front surface of this transferable sheet defines a raised pattern. The method involves a step in which:

b) Using a polyurethane-based solution having a high solids content having partial, prematurely blocked polymerisation, one forms a shape-holding layer for the transferable sheet.

Advantageously, in step b), one forms a film with said solution having a high solids content and one then dries said film and continues polymerisation of the polyurethane that is present in this film.

Advantageously, in step b), one continues polymerisation of the polyurethane that is present in said film by subjecting the film to heating.

Advantageously, this method involves a step in which:

a) Using a polymerised polyurethane-based resin solution, one forms a strengthening layer for the transferable sheet.

In this case, the shape-holding layer and the strengthening layer are formed on top of each other in steps a) and b).

Advantageously, the transferable sheet is formed on an impression that defines a negative of said raised pattern and the method involves a step that takes place after step b) and in which:

c) One separates the transferable sheet from said impression.

Advantageously, step b) takes place after step a) in which one deposits the polyurethane-based polymerised resin solution in the form of a film on said impression and one then dries this film. If this is the case, one forms the shape-holding layer on the strengthening layer in step b).

Advantageously, in step a), one first forms a superficial portion of the strengthening layer in the recessed areas of the impression and, on this superficial portion, one then forms an underlying portion of the strengthening layer, with the superficial portion and the underlying portion of the strengthening layer having different colours.

Advantageously, this method involves a step which follows step c) and in which:

d) One combines the transferable sheet and a peel-off backing sheet with each other so that the peel-off backing sheet is located on the opposite side to a thermofusible bonding layer that is part of the transferable sheet.

### BRIEF DESCRIPTION OF THE DRAWINGS

The present invention will be made more readily understandable by the following description which is given merely by way of example and relates to the accompanying drawings in which:

FIG. 1 is a schematic cross-sectional view of a portion of a product that is suitable for use with the hot-press transfer technique in accordance with the invention;

FIG. 2 is a diagram showing a plant in which a transferable sheet is produced by hot-pressing and is intended to be part of the product shown in FIG. 1;

FIG. 3 is a diagram showing a plant in which the product shown in FIG. 1 is produced from the transferable sheet produced in the plant shown in FIG. 2;

FIG. 4 is a schematic perspective view of the product shown in FIG. 1 before it is used;

FIG. 5 is a view similar to FIG. 4 showing the same product as in FIGS. 1 and 4 and shows a preparatory step prior to use of the product in a transferable sheet from which a decorative pattern that is to be transferred by hot-pressing has been cut out; and

FIG. 6 is a schematic view of a garment provided with the decorative pattern shown in FIG. 5 and illustrates an operation that follows hot-press transfer of this decorative pattern.

### DETAILED DESCRIPTION OF THE INVENTION

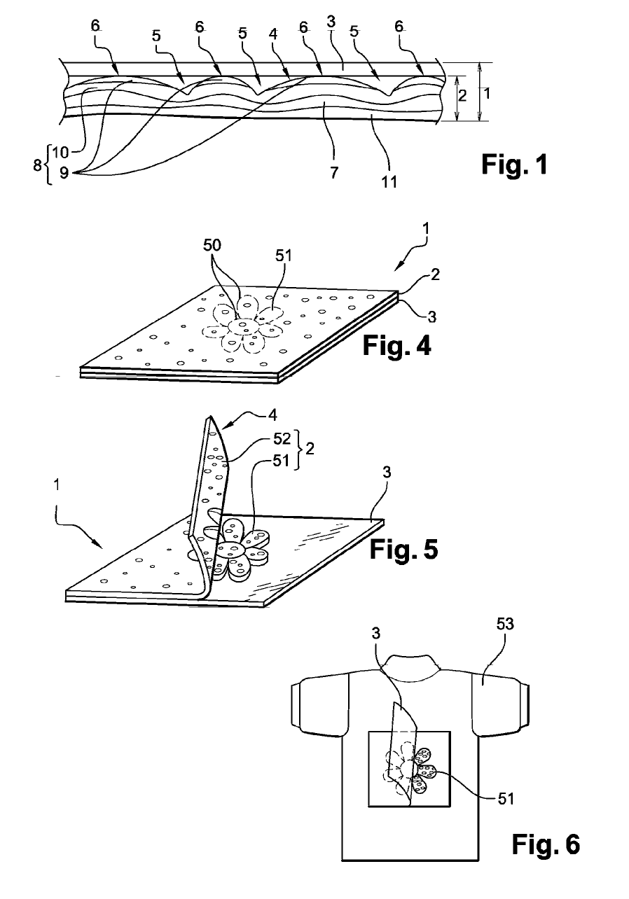

FIG. 1 shows a product 1 which is intended to be used to decorate a garment by means of hot-press transfer and which comprises two sheets combined with each other, back to back, namely a multilayer sheet 2 that can be transferred by hot-pressing and a peel-off backing sheet 3.

In the following text and in the appended claims, the terms “back”, “front” and similar terms refer to transferable sheet 2 after it has been transferred to a fabric as viewed by an observer who is looking at transferable sheet 2.

The front surface 4 of transferable sheet 2 comprises recessed areas 5 and protruding areas 6 which alternate with each other and together form a raised pattern. This raised pattern is defined by two superposed layers 7 and 8 of transferable sheet 2. In the example suggested here as one possible way of implementing the invention, this pattern is a grain that imitates the grain of natural leather.

Layer 7 of transferable sheet 2 is more precisely a shape-holding layer designed to prevent hot-press transfer of this sheet causing this raised to pattern to disappear, i.e. the grain in the example suggested here. It is made of polyurethane (PU) in a manner that is explained below.

Layer 8 of transferable sheet 2 is also made of polyurethane (PU). This layer is a strengthening layer which is not manufactured in the same way as shape-holding layer 7 but is intimately bonded to the latter thanks to chemical compatibility and has the function of increasing the strength of transferable sheet 2 in order to withstand mechanical stresses such as tensile forces. The particular role of strengthening layer 8 is to increase the ability of transferable sheet 2 to stretch elastically when subjected to tensile forces, thus preventing crazing of transferable sheet 2 once it has been attached to the target garment. It also defines the front surface 4 to which it gives a smooth, non-tacky touch.

Strengthening layer 8 may be the same colour throughout, i.e. be a single colour. It may also be different coloured. This is the case in the example shown where the colour of strengthening layer 8 is not the same at every point. In the protruding areas 6, a superficial portion 9 of strengthening layer 8 is a first colour. An underlying portion 10 of strengthening layer 8 is a second colour which is different to the first colour. These first and second colours can be chosen so as to accentuate the raised look of front surface 4 and/or so that front surface 4 looks really similar to the external surface of a natural leather.

Besides layers 7 and 8, transferable sheet 2 comprises a thermofusible bonding layer 11 which can, in particular, be copolyester based and covers the back surface of shape-holding layer 7 which is opposite strengthening layer 8. This bonding layer 11 is designed to securely attach layers 7 and 8 to the target fabric.

Backing sheet 3 consists of a transparent film made of polyethylene teraphthalate (PET) and has one side that is tacky, i.e. provided with an adhesive that allows it to be stuck to a surface several times and then detached. In fact, this tacky side is bonded to front surface 4 of transferable sheet 2 so that backing sheet 3 can be peeled off, i.e. be detached from transferable sheet 2. The other side of backing sheet 3 undergoes a non-stick treatment so that it can be detached easily, thereby allowing product 1 to be wound before use and then easily unwound.

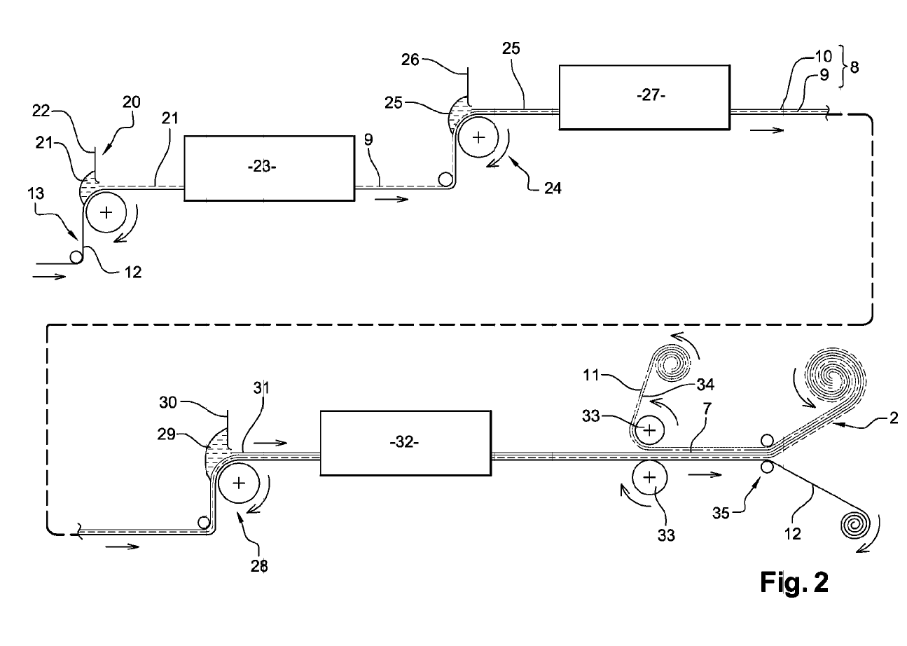

A plant for manufacturing transferable sheet 2 is shown in FIG. 2 where the arrows indicate the directions of the various feed or rotation movements. Layers 7 and 8 of sheet 2 are produced first using a technique known as “transfer coating” in which a coating is applied to a temporary base material. In the example shown, this temporary base material consists of grained paper 12, which is commonly referred to as transfer paper, one side of which 13 defines a mould impression. This mould impression comprises indentations that match protruding areas 6 and protrusions that match indentations 5. Its shape is therefore a negative of the embossing that is intended to be defined by front surface 4. In other respects, paper 12 is a conventional transfer paper such as that marketed under the brand name EMBOSSED DOLARO by the firm FAVINI CARTIERA, via 4 novembre, 276—28882 CRUSINALLO/OMEGNA (VB)—ITALY.

A first coating station 20 of the system shown in FIG. 2 is used to deposit solution 21 on surface 13 of transfer paper 12. This solution 21 contains a fully polymerised polyurethane-based resin that is a first colour and is dissolved in a solvent. A doctor blade 22 determines the quantity of solution 21 left on surface 13 of transfer paper 12. The blade is adjusted so that solution 21 is only left in the indentations defined by surface 13, i.e. in the indentations that match protruding areas 6.

After coating station 20, transfer paper 12 goes into a first drying oven 23 where the solvent in solution 21 is evaporated. When it leaves oven 23, superficial portion 9 of strengthening layer 8 is formed in the indentations in surface 13. It consists of the non-volatile matter in solution 21, i.e. the polyurethane-based resin contained in solution 21. After drying, superficial portion 9 is distributed with a surface density which can, for example, be of the order of 10 g/m². A solution 21 consisting of 59% by weight Larithane marketed under the brand name MS 128 by the firm NOVOTEX ITALIANA SPA, 39.4% by weight dimethylformamide (DMF), 0.44% by weight Norene black marketed under the brand name S1052 by aforementioned firm NOVOTEX ITALIANA SPA, 1.06% by weight Norene orange marketed under the brand name S3188 by aforementioned firm NOVOTEX ITALIANA SPA and 0.1% by weight Noresil marketed under the brand name S 900 by aforementioned firm NOVOTEX ITALIANA SPA, whose address is via Enrico Fermi, 20—20083 GAGGIANO (MI)—ITALY, has produced good results.

Drying in oven 23 is followed by a second coating operation. This takes place at a second coating station 24 where solution 25 is deposited on superficial portion 9 and on those areas of surface 13 of transfer paper 12 that are still exposed. This solution 25 has substantially the same chemical composition as solution 21, but the colour of its non-volatile matter is nevertheless different. A doctor blade 26 on coating station 24 determines the quantity of solution 25 that is deposited and the assembly is then moved into second drying oven 27 where the solvent is evaporated from solution 25. After drying, the solid content of deposited solution 25 forms underlying portion 10 of strengthening layer 8. Its surface density can then be, for example, of the order of 30 g/m².

When strengthening layer 8 has been formed on transfer paper 12, the assembly is transported to third coating station 28 where polyurethane-based solution 29 is deposited on the exposed side of strengthening layer 8. This solution 29 has a high solid content and is also referred to as a “high-solid solution” in which the polyurethane-based solid content is high compared to that of a normal polyurethane solution such as solutions 21 and 25.

The proportion of non-volatile matter in the high-solid solution is advantageously in excess of 70% by weight and preferably in excess of 85% by weight, for instance of the order of 95% by weight.

For example, solution 29 may contain only 5% solvent by weight whereas the proportion of solvent in solutions 21 and 25 is of the order of 70% by weight. The polyurethane in solution 29 is partially polymerised which means that its polymerisation has been prematurely blocked. A solution 29 consisting of 91.41% by weight UCECOAT SV 201, 6.76% by weight UCECOAT IT 131, 0.46% by weight UCECOAT AS 20, 0.46% by weight UCECOAT R446/50, 0.46% by weight UCECOAT AS 41 and 0.46% by weight flatting agents, marketed under the brand name TS 100 by the firm SAFIC-ALCAN, 3, rue Bellini—92806 PUTEAUX—FRANCE, has produced good results. Solution 29 has the composition defined above and is colourless. Solution 29 may also be coloured in which case the colorants are part of its composition. Products UCECOAT SV 201, UCECOAT IT 131, UCECOAT AS 20, UCECOAT R446/50 and UCECOAT AS 41 are available from the firm CYTEC—Anderlecht Str 33—1620 DROGENBOS—BELGIUM.

A doctor blade 30 determines the quantity of solution 29 that is deposited in the form of film 31 on strengthening layer 8. The assembly is then transported to drying oven 32 where the solvent in solution 29 is evaporated. After drying, film 31 may, for example, have a surface density of the order of 80 to 100 g/m².

The conveyor belt from oven 32 is driven by two heated calendaring rollers 33 between which the belt passes. Thermofusible bonding layer 11 carried on temporary polyethylene film 34 also passes between calendaring rollers 33 which attach it by heating it and pressing it against dry film 31. A thermofusible layer marketed under the brand name FAITERM 104 by Italian firm FAITPLAST, Via industriale—25060 CELLATICA (BR)—ITALY has produced good results when used as bonding layer 11.

The heat provided by oven 32 and/or provided by calendaring rollers 33 causes polymerisation of the polyurethane in film 31 to continue so that this polymerisation is finished after film 31 has been formed. Once the polyurethane it contains has been polymerised, film 31 constitutes shape-holding layer 7.

The penultimate operation is performed by plant as shown in FIG. 2 and involves releasing transferable sheet 2 from the impression by separating it from transfer paper 12 in 35. Transferable sheet 2 can then be wound, cut into sheets or packaged in other ways.

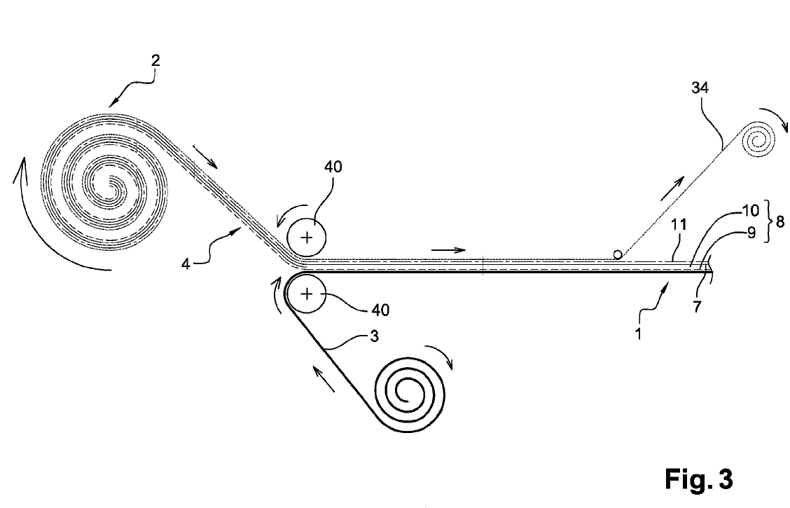

Product 1 can be produced from transferable sheet 2 obtained from a plant as shown in FIG. 2 and from a strip of backing sheet 3 obtained from a plant as shown in FIG. 3 where the arrows indicate the directions of feed or rotation movements. In FIG. 3, transferable sheet 2 and backing sheet 3 together pass through two calendaring rollers 40 which press them against each other so as to stick the adhesive side of backing sheet 3 against front surface 4 of transferable sheet 2. The two calendaring rollers 40 are heated in order to heat the adhesive that is present on the adhesive side of backing sheet 3. A polythene terephthalate sheet marketed under the brand name ETL115142 by the firm BISCHOF+KLEIN GmbH—Rahestraβe 47 —49525 LENGERICH—GERMANY has given good results when used as backing sheet 3.

When transferable sheet 2 and backing sheet 3 have been attached to each other, temporary film 34 is removed, after which product 1 is finished.

FIGS. 4 and 5 illustrate the first steps in using product 1. FIG. 4 shows a sample of product 1, on the transferable sheet 2 whereof the outline 50 of a decorative pattern that is to be cut out 51 is marked in a dotted line. Using an appropriate device such as a graphic cutter, one cuts out decorative pattern 51 from transferable sheet 2 without cutting peel-off backing sheet 3. Following this, only decorative pattern 51 that is to be transferred is left on peel-off backing sheet 3, the off cuts 52 produced by cutting having been removed, as shown in FIG. 5.

The transparency of backing sheet 3 makes it easier to position decorative pattern 51 prior to attaching it to a garment such as a T-shirt. It is attached by hot-pressing. In a manner that is known in itself, attachment involves pressing decorative pattern 51 complete with peel-off backing sheet 3 against the garment, using a hot press or an electric iron. During this process, bonding layer 11 of decorative pattern 51 softens or even melts, thus allowing it to attach to the fibres of the target garment.

In FIG. 6, decorative pattern 51 has been attached to garment 53 by hot-pressing. Bonding layer 11, once cooled and solidified, attaches decorative pattern 51 to the fabric of garment 53. Peel-off backing sheet 3 can be removed and separated from decorative pattern 51, as illustrated in FIG. 6.

It has been demonstrated that, surprisingly, the embossing of front surface 4 withstands hot-press transfer thanks to the presence of shape-holding layer 3 in transferable sheet 2.

The invention is not confined to the embodiment described above. In particular, the plant shown in FIG. 2 can be broken down into several separate subassemblies, even though grouping these subassemblies together enables continuous operation.

In addition, hot-press transfer of transferable sheet 2 or part thereof can be achieved on a target base material other than a fabric by making a few adjustments that are within the ability of those skilled in the art. For example, the target base material can be a dashboard, an interior trim component or a passenger compartment shelf of a motor vehicle or some other accessory such as a passenger compartment.

In addition, shape-holding layer 7 can be made of a foamed plastic and have a cellular structure. To achieve this, a foaming agent can be incorporated in solution 25. For example, this can be azodicarbonamide which reacts with the heating drying oven 27 by releasing a blowing gas. Roughly 5 to 6% by weight azodicarbonamide of the mass of resin in solution 25 has given good results. Foaming of the material of shape-holding layer 7 can be obtained in another way other than by using azodicarbonamide. For example, this can be obtained by microspheres that are added to solution 25 and contain a gas that is intended to cause them to dilate due to the effect of a temperature rise.

1. A product for decorating a base material by hot-press transfer, comprising a sheet transferable onto a base material via hot-pressing, characterised in that a raised pattern is defined by a front surface of the transferable sheet which comprises at least one shape-holding layer that is obtained from a polyurethane-based high solids content solution having partial, prematurely blocked polymerisation.

2. The product as claimed in claim 1, characterised in that the sheet comprises a strengthening layer that covers said shape-holding layer and results from the drying of a polyurethane-based fully polymerised resin solution.

3. The product as claimed in claim 2, characterised in that said strengthening layer defines the front surface of the transferable sheet and comprises a superficial portion which has a different colour than an underlying portion of said strengthening layer and which is located in areas that protrude from said front surface.

4. The product as claimed in claim 1, characterised in that the transferable sheet comprises a bonding layer for bonding to a base material by hot-pressing.

5. The product as claimed in claim 4, characterised in that, the sheet comprises a strengthening layer that covers said shape-holding layer and results from the drying of a polyurethane-based fully polymerised resin solution, wherein, on the side of said shape-holding layer that is opposite to said strengthening layer, said bonding layer covers a face of said shape-holding layer.

6. The product as claimed in claim 4, further comprising a backing sheet that carries the transferable sheet without covering said bonding layer and is separable from the transferable sheet.

7. A method for manufacturing a product for decorating a base material by hot-press transfer, the product comprising a sheet transferable onto a base material via hot-pressing and characterised in that a front surface of the transferable sheet defines a raised pattern, the method comprising:
using a polyurethane-based solution having a high solids content having partial, prematurely blocked polymerisation to form a shape-holding layer for the transferable sheet.

8. The method as claimed in claim 7, characterised in that, the step of using a polyurethane-based solution to form a shape-holding layer comprises forming a film with said high solids content solution, and drying said film to continue polymerisation of the polyurethane that is present in the film.

9. The method as claimed in claim 8, characterised in that, continuing polymerisation of the polyurethane that is present in said film comprises subjecting the film to heating.

10. The method as claimed in claim 7 further comprising the step of:
using a polymerised polyurethane-based resin solution to form a strengthening layer of the transferable sheet.

11. The method as claimed in claim 7, characterised in that the transferable sheet is formed on an impression which defines a negative of said raised pattern, further comprising the step of:
separating the transferable sheet from said impression.

12. The method as claimed in claim 10 wherein:
the transferable sheet is formed on an impression which defines a negative of said raised pattern;
the step of using a polyurethane-based solution to form a shape-holding layer takes place after the step of using the polyurethane-based polymerised resin solution to form a strengthening layer, during which the polyurethane-based polymerised resin solution is deposited in the form of a film on said impression and then dried,
wherein the shape-holding layer is formed on the strengthening layer;
further comprising the step of separating the transferable sheet from said impression.

13. The method as claimed in claim 12, characterised in that, the step of using the polyurethane-based polymerised resin solution to form a strengthening layer comprises first forming a superficial portion of the strengthening layer in recessed areas of the impression and, on this superficial portion, then forming an underlying portion of the strengthening layer, with the superficial portion and the underlying portion of the strengthening layer having different colours.

14. The method as claimed in claim 11, further comprising the step of:
combining the transferable sheet with a peel-off backing sheet so that the peel-off backing sheet is located on the opposite side as a thermofusible bonding layer that is part of the transferable sheet.
